(19) United States
(12) Patent Application Publication
(10) Pub. No.: US 2017/0093251 A1
(43) Pub. Date: Mar. 30, 2017

(54) Driving Mechanism And Vehicle Utilizing The Driving Mechanism

(71) Applicant: Johnson Electric S.A., Murten (CH)

(72) Inventors: Yue LI, Hong Kong (CN); Chui You ZHOU, Shenzhen (CN); Yong WANG, Shenzhen (CN); Yong LI, Shenzhen (CN)

(21) Appl. No.: 15/274,128

(22) Filed: Sep. 23, 2016

(30) Foreign Application Priority Data
Sep. 30, 2015 (CN) 201510646040.8

(51) Int. Cl. H02K 7/116; E05F 15/697; H02K 3/18; H02K 21/02; H02K 1/14

(52) U.S. Cl. CPC H02K 7/1166; H02K 21/02; H02K 1/14; H02K 3/18; E05F 15/697; E05Y 2900/55

(57) ABSTRACT

A driving mechanism and a vehicle utilizing the driving mechanism are provided. The driving mechanism includes a box, a motor, and a buffering member. The motor is at least partially received in the box. The buffering member is attached to an outer circumference of the motor and disposed between the motor and the box. The above driving mechanism has an improved vibration buffering effect.

### CROSS REFERENCE TO RELATED APPLICATIONS

This non-provisional patent application claims priority under 35 U.S.C. §119(a) from Patent Application No. 201510646040.8 filed in The People's Republic of China on Sep. 30, 2015.

### FIELD OF THE INVENTION

The present invention relates to a driving mechanism and a vehicle utilizing the driving mechanism.

### BACKGROUND OF THE INVENTION

Open and close of a vehicle window is usually achieved by a driving mechanism. The driving mechanism generally includes a box, and a motor and a transmission assembly disposed in the box. When rotating, the motor drives the vehicle window to open or close through the transmission assembly. The traditional motor is fixedly connected to the box through its outer housing. In order to buffer the vibrations produced by the motor during operation and reduce the operational noises, a buffering member is usually disposed at a connection area between one end of the motor housing and the box. However, due to the limitations of the motor mounting structure, the buffering member contacts only the end of the motor housing and the box, which has a small contact area and pre-deformation area for buffering the vibrations. As a result, an ideal vibration buffering effect can be difficult to achieve.

### SUMMARY OF THE INVENTION

Accordingly, there is a desire for a driving mechanism with improved vibration buffering effect, and a vehicle utilizing the driving mechanism.

A driving mechanism includes a box, a motor and a buffering member. The motor is at least partially received in the box. The buffering member is attached to an outer circumference of the motor disposed between the motor and the box.

Preferably, the driving mechanism further comprises a cover body, the box comprises a first receiving portion, the motor is disposed in the first receiving portion, and the cover body covers a portion of the motor that is exposed out of the first receiving portion.

Preferably, the buffering member comprises a sleeve portion attached around the outer circumference of the motor and a buffering portion disposed on the sleeve portion, and the buffering portion is disposed between the sleeve portion and the first receiving portion.

Preferably, a structure of the buffering portion comprises at least one type of an elongated buffering protrusion, a ball-shaped buffering protrusion and a prism-shaped buffering protrusion.

Preferably, the buffering member further comprises a retaining portion, the retaining portion is a flange disposed at one end of the sleeve portion, and the retaining portion is sandwiched between the cover body and the first receiving portion of the box.

Preferably, the first receiving portion defines a receiving chamber, the motor is at least partially received in the receiving chamber, the driving mechanism further comprises a transmission assembly, the box further comprises a second receiving portion defining a receiving slot, the receiving slot is in communication with the receiving chamber, and the transmission assembly is disposed in the receiving slot and connected to the motor.

Preferably, the motor is a permanent magnet brushless motor.

Preferably, the motor is a single phase permanent magnet brushless motor.

Preferably, the motor comprises a stator and a rotor, the stator comprises a stator core and a winding, the stator core comprises a stator yoke and stator teeth coupled to the stator yoke, the winding is wound around the stator teeth, the buffering member is disposed at an outer circumference of the stator core, and the rotor is received in the stator core.

Preferably, the stator yoke comprises two opposite first sidewalls and two opposite second sidewalls, the first sidewalls and the second sidewalls are connected such that the stator yoke is substantially rectangle shaped, the stator teeth are coupled to the first sidewalls.

Preferably, a maximal distance between outer surfaces of the two first sidewalls is greater than a maximal distance between outer surfaces of the two second sidewalls.

Preferably, the number of the stator teeth is two, each stator tooth comprises a winding portion and pole shoes coupled to the winding portion, the winding portion is connected to one corresponding first sidewall, the pole shoes are disposed at one end of the winding portion away from the first sidewall and faces toward the rotor, and the winding comprises two coils each wound around the winding portion of one corresponding stator tooth.

Preferably, one side of each second sidewall facing toward the rotor forms two extensions, one end of each extension away from the second sidewall extends in a direction away from the second sidewall and away from the other extension, all the pole shoes and all the extensions cooperatively define a receiving space in which the rotor is received.

Preferably, each pole shoe and the adjacent extension are connected by a magnetic bridge or interrupted by an opening.

Preferably, one side of the pole shoe facing toward the rotor defines a recess, and one side of the extension facing toward the rotor defines a recess.

Preferably, the rotor comprises a rotary shaft ratatably disposed in the box, a rotor core disposed around the rotary shaft, and a plurality of permanent magnetic poles disposed around the rotor core.

Preferably, the number of the permanent magnetic poles is four, and the four permanent magnetic poles are spaced along a circumferential direction of the rotor core.

Preferably, outer surfaces of the permanent magnetic poles are located on a same cylindrical surface.

Preferably, an outer surface of each permanent magnetic pole is spaced from a center of the rotor by a distance that progressively decreases in a circumferential direction of the rotor from a middle to two ends of the outer surface and is symmetrical with respect to a center line of the outer surface.

Preferably, the box includes a weight-reduction portion formed thereon.

Preferably, the weight-reduction portion is a groove or through hole in the box.

The present invention further provides a vehicle. The vehicle includes a vehicle window and the driving mechanism as described above. The motor is connected to the vehicle window through a transmission assembly of the driving mechanism and is capable of driving the vehicle window to move.

In the above driving mechanism, the motor can be partially received in the box, and the buffering member is provided at the outer circumference of the motor. Therefore, the buffering member is directly disposed between the outer circumferential surface of the motor and the box, and the contact area and pre-deformation area for buffering the vibrations are increased. As a result, the buffering member can effectively absorb the vibrational energy produced by the driving mechanism during operation. Therefore, the buffering member has an improved vibration buffering effect, and the driving mechanism operates with improved stability and reduced noises.

### BRIEF DESCRIPTION OF THE DRAWINGS

FIG. 1 is a perspective view of a driving mechanism according to one embodiment of the present invention.

FIG. 2 is an exploded, perspective view of the driving mechanism of FIG. 1.

FIG. 3 is a sectional view of the driving mechanism of FIG. 1.

FIG. 4 is an enlarged view of the portion IV of the driving mechanism of FIG. 3.

FIG. 5 is a perspective view of a driving assembly of the driving mechanism of FIG. 2.

FIG. 6 is an exploded, perspective view of the driving assembly of FIG. 5.

FIG. 7 is a cross-sectional view of the driving assembly of FIG. 5.

FIG. 8 is a sectional view of the driving mechanism of FIG. 1, viewed from another direction.

FIG. 9 is a perspective view of a buffering member of the driving mechanism of FIG. 2.

FIG. 10 illustrates the driving mechanism of FIG. 1 used in a vehicle.

### DETAILED DESCRIPTION OF THE PREFERRED EMBODIMENTS

The technical solutions of the embodiments of the present invention will be clearly and completely described as follows with reference to the accompanying drawings. Apparently, the embodiments as described below are merely part of, rather than all, embodiments of the present invention. Based on the embodiments of the present disclosure, any other embodiment obtained by a person skilled in the art without paying any creative effort shall fall within the protection scope of the present invention.

It is noted that, when a component is described to be “fixed” to another component, it can be directly fixed to the another component or there may be an intermediate component, i.e. indirectly fixed to the another component through a third component. When a component is described to be “connected” to another component, it can be directly connected to the another component or there may be an intermediate component. When a component is described to be “disposed” on another component, it can be directly disposed on the another component or there may be an intermediate component. The directional phraseologies such as “perpendicular”, “horizontal”, “left”, “right” or similar expressions are for the purposes of illustration only.

Unless otherwise specified, all technical and scientific terms have the ordinary meaning as understood by people skilled in the art. The terms used in this disclosure are illustrative rather than limiting. The term “and/or” as used in this disclosure means that each and every combination of one or more associated items listed are included.

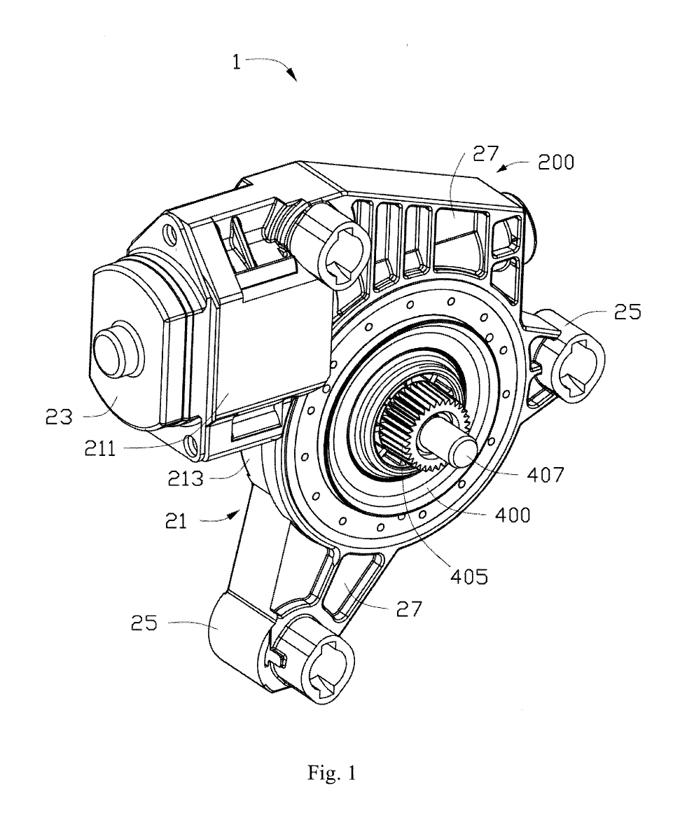

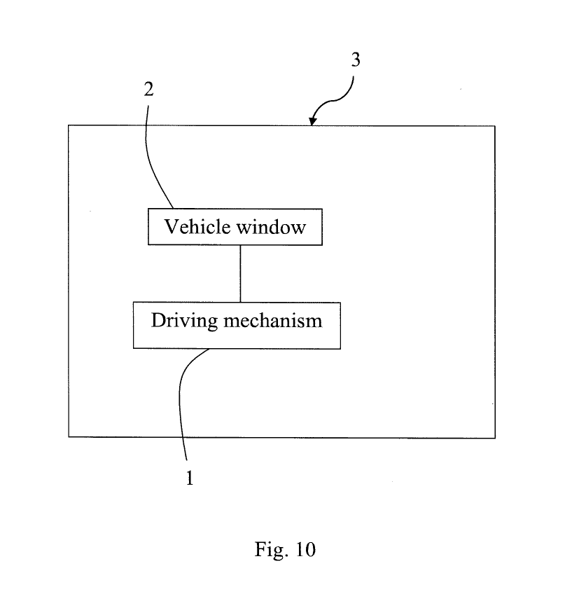

Referring to FIG. 1, a driving mechanism 1 in accordance with one embodiment of the present invention is used to drive an external device to rotate or drive the external device to translate through a transmission mechanism. In particular, the external device may be a vehicle window 2 (as shown in FIG. 10). By controlling the driving mechanism 1 to operate, the vehicle window 2 can be driven to open or close. Alternatively, the external device may be another movable device such as a wheel of a toy car or fan blades, which will be described in detail below.

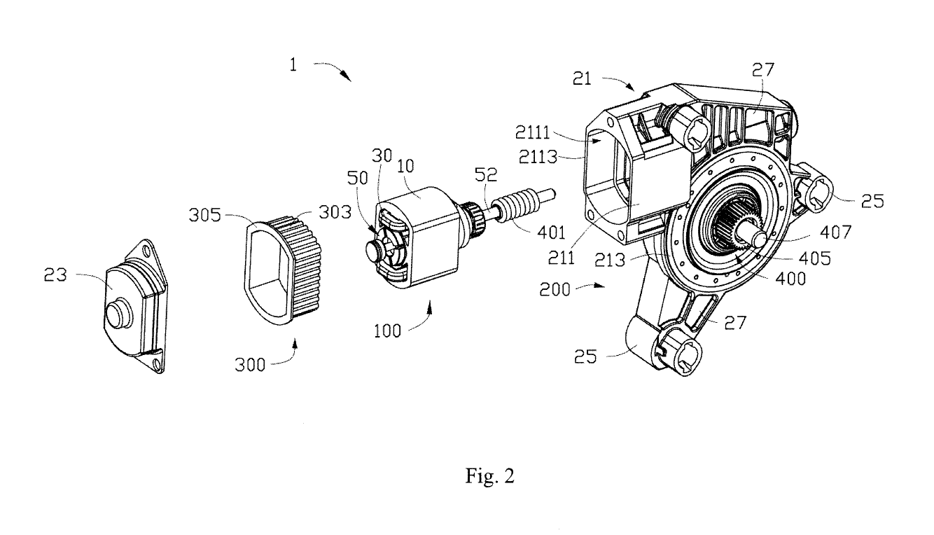

Referring to FIG. 2, the driving mechanism 1 includes a mounting assembly 200, a driving assembly 100, a buffering member 300, and a transmission assembly 400. In this illustrated embodiment, specifically, the driving assembly 100, the buffering member 300 and the transmission assembly 400 are all disposed on the mounting assembly 200. The transmission assembly 400 is connected to the driving assembly 100. The mounting assembly 200 is configured to mount the driving mechanism 1 to the external device, for allowing the driving assembly 100 to drive the external device to move through the transmission assembly 400.

The buffering member 300 is disposed between the driving assembly 100 and the mounting assembly 200. The buffering member 300 is used to absorb vibrational impact produced by the driving assembly 100 to reduce vibrations transmitted to the mounting assembly 200 and the transmission assembly 400, thereby reducing the overall vibrations and noises of the driving mechanism 1.

The mounting assembly 200 includes a box 21, a cover body 23, and mounting portions 25. In the illustrated specific embodiment, the cover body 23 covers on the box 21, and the mounting portions 25 are connected to the box 21.

In this embodiment, the box 21 is a gearbox, which receives the driving assembly 100 and the transmission assembly 400. The box 21 includes a first receiving portion 211 and a second receiving portion 213 disposed adjacent to the first receiving portion 211.

The first receiving portion 211 defines a generally column shaped receiving chamber 2111 for receiving the driving assembly 100. The receiving chamber 2111 includes an opening 2113. The receiving chamber 2111 communicates with the outside environment via the opening 2113.

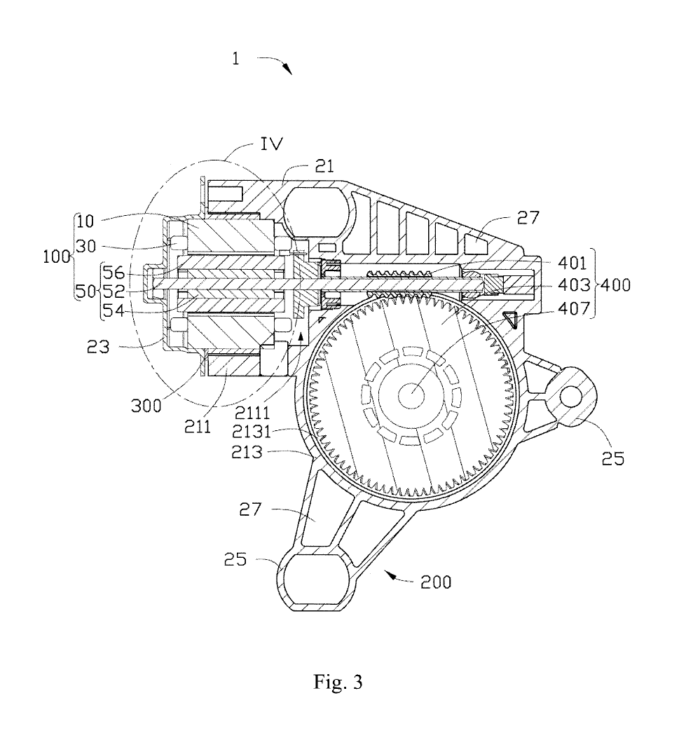

Referring to FIG. 3, the second receiving portion 213 defines a receiving slot 2131 that is generally circular disc-shaped, for receiving the transmission assembly 400. The receiving slot 2131 communicates with the receiving chamber 2111 at one side of the receiving slot 2131, for allowing the transmission assembly 400 to engage with the driving assembly 100 at this communication area between the receiving slot 2131 and the receiving chamber 2111.

The cover body 23 covers the opening 2113 and is detachably connected with the box 21. The cover body 23 is used to close the receiving chamber 2111, such that the receiving chamber 2111 and the receiving slot 2131 are substantially isolated from the outside environment to achieve a dustproof seal.

In this embodiment, the number of the mounting portions 25 is three. The three mounting portions 24 are spaced and disposed around the second receiving portion 213. The mounting portions 25 are used to connect to the external device so as to mount the driving mechanism 1 to the external device. It should be understood that the number of the mounting portions 25 is not intended to be limited to three, which can also be two or four.

Further, in order to reasonably reduce the overall weight of the mounting assembly 200 while ensuring a certain rigidity of the mounting assembly 200, part of the material of the box 21 and/or the mounting portions 25 are removed to form a plurality of spaced weight-reduction sections 27 arranged on the box 21 and/or the mounting portions 25. In this embodiment, the weight-reduction sections 27 are through-hole structures passing through the box 21 and/or the mounting portions 25. It should be understood that the weight-reduction sections 27 may also be groove structures formed in the box 21 and/or the mounting portions 25.

Referring again to FIG. 2, in this embodiment, the driving assembly 100 is a single phase permanent magnet motor. Preferably, the driving assembly 100 is single phase permanent magnet brushless motor. The driving assembly 100 is partially received in the first receiving portion 211, for driving the transmission assembly 400 to move which further drives the external device to move.

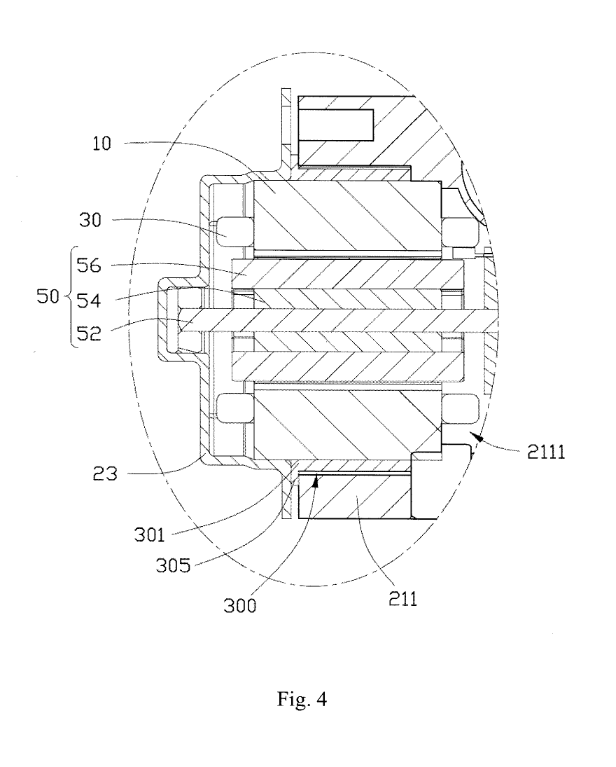

Referring to FIG. 3 and FIG. 4, at least part (in this embodiment, a large part) of the driving assembly 100 is received in the first receiving portion 211 of the box 21, and the cover body 23 covers one end of the driving assembly 100 and is fixedly connected to the box 21 through fasteners such as screws, such that the driving mechanism 1 overall has a smaller size, and the size of the external device utilizing the driving mechanism 1 can therefore be reduced.

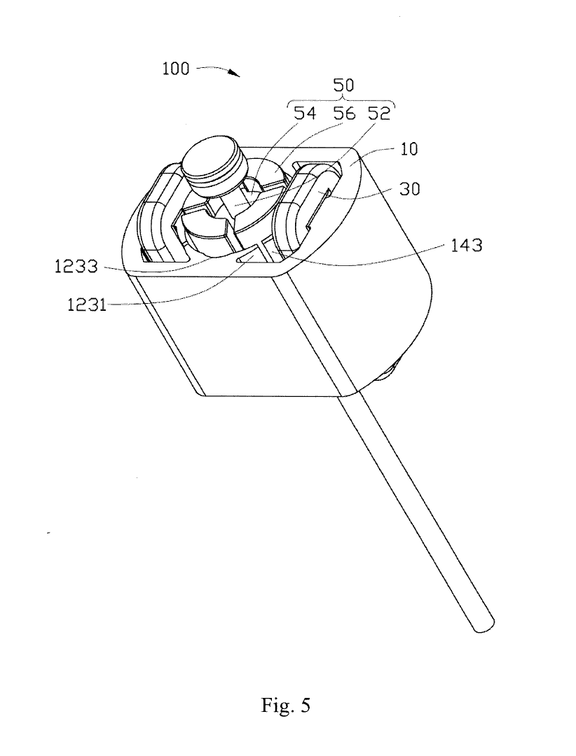

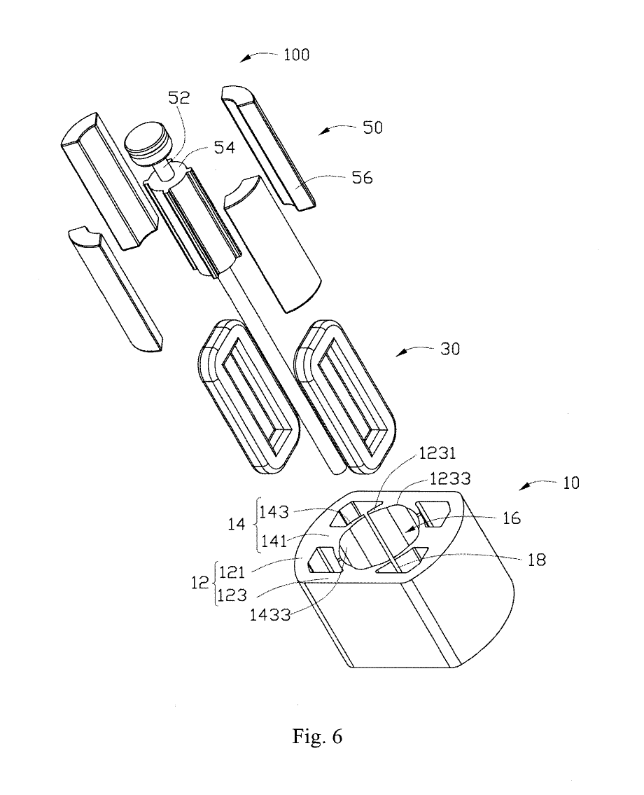

Referring to FIG. 5 and FIG. 6, the driving assembly 100 includes a stator core 10, a winding 30, and a rotor 50. In the illustrated specific embodiment, the driving assembly 100 is an inner rotor motor, the stator core 10 is received in the box 21 of the mounting assembly 200, the winding 30 is wound around the stator core 10, the rotor 50 is rotatably received in the stator core 10 and connected to the transmission assembly 400.

The stator core 10 includes a stator yoke 12 and stator teeth 14. In the illustrated specific embodiment, the stator teeth 14 extend inwardly from the stator yoke 12. The stator yoke 12 is directly fixedly mounted within the first receiving portion 211 of the box 21. As a result, an outer housing of a traditional motor is omitted from the driving assembly 100. That is, part of the box 21 forms the outer housing of the motor, which further reduces the size and weight of the external device utilizing the driving mechanism 1.

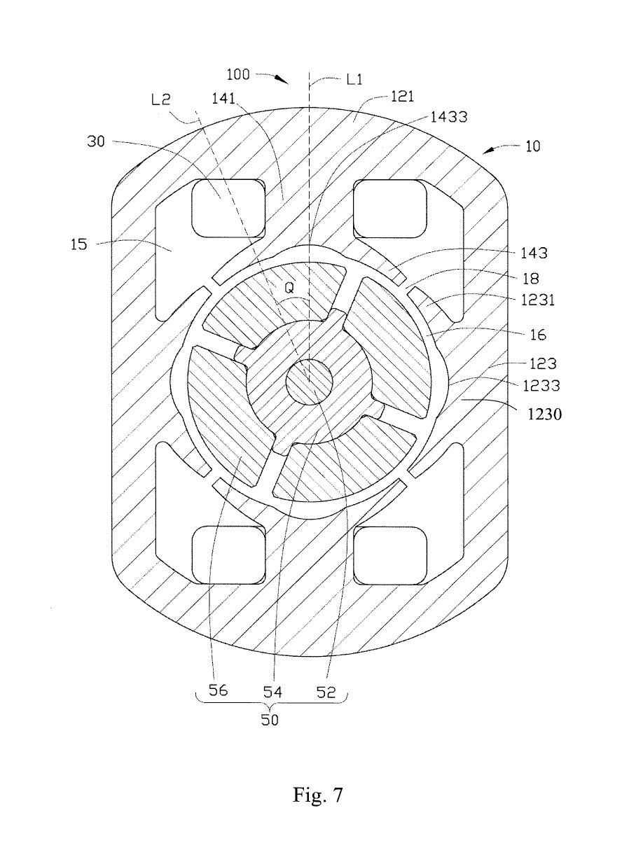

Referring also to FIG. 7, which is a cross-sectional view of the driving assembly 100 according to one embodiment of the present invention. The cross-section as used in this disclosure refers to an axial section, i.e. a section formed by a plane cutting through the driving assembly 100, wherein the plane is perpendicular to the rotary shaft of the driving assembly 100. A cross-section of the stator yoke 12 is substantially in the shape of a closed rectangle, including two arcuate first sidewalls 121 and two flat second sidewalls 123. The two first sidewalls 121 are disposed opposing to each other, the two second sidewalls 123 are disposed opposing to each other, and two distal ends of each second sidewall 123 are connected to two distal ends of the two first sidewalls 121, respectively, such that the cross-section of the stator yoke 12 is in the shape of a continuously closed ring.

In this embodiment, specifically, outer circumferential surfaces of the first sidewalls 121 are substantially a part of a cylindrical surface, such that the outer profile of the cross-section of the first sidewall 121 is in the shape of a circular arc. Inner surfaces of the first sidewalls 121 are substantially flat surfaces and, therefore, each first sidewall 121 has a thickness that is smaller at two sides than at a middle thereof. An outer circumferential surface of each second sidewall 123 is substantially a flat surface, such that the outer profile of the cross-section of the second sidewall 123 is generally a straight line segment.

An inner surface of each second sidewall 123 is provided with an auxiliary tooth 1230. The auxiliary tooth 1230 includes two extensions 1231. The extensions 1231 are used to conduct magnetic flux and assist the stator teeth 14 to form magnetic flux loops. One end of each extension 1231 is a connecting end (not labeled), and the other end is an extension end (not labeled). The connecting ends of the two extensions 1231 are connected with each other and connected to a substantially middle position of the second sidewall 123. The extension ends of the two extensions 1231 both extend in a direction away from the second sidewall 123, and the extension ends of the two extensions 1231 are spaced away from each other, such that an outer profile of cross-sections of the two extensions 1231 is substantially V-shaped or arc-shaped.

In this embodiment, the number of the stator teeth 14 is two. The stator teeth 14 are connected to the inner surfaces of the first sidewalls 121, respectively, for allowing the winding 30 to be wound thereon.

In the illustrated embodiment, specifically, each stator tooth 14 is substantially Y-shaped, including a winding portion 141 and two pole shoes 143. The winding portion 141 extends radially inwardly from a middle of the inner surface of the first sidewall 121. The two pole shoes 143 are disposed at one end of the winding portion 141 away from the corresponding first sidewall 121.

In this embodiment, the two pole shoes 143 of each stator tooth 14 extend from a distal end of the winding portion 141 along a circumferential direction of the rotor 50, toward two adjacent extensions 1231 at opposite sides of the winding portion 141, respectively, such that an outer profile of cross-sections of the two pole shoes 143 is substantially V-shaped or arc-shaped, and hence the two pole shoes 143 and the winding portion 141 cooperatively form the Y-shaped profile of the stator tooth 14. The pole shoes 143 can prevent the winding 30 from falling off the winding portion 141 and, at the same time, can be used to conduct magnetic flux.

Similar to the construction of the extension 1231, each pole shoe 143 has one end as a connecting end (not labeled) and the other end as an extension end (not shown). The connecting ends of the two pole shoes 143 are connected with each other and connected to one side of the winding portion 141 away from the first sidewall 121. The extension ends of the two pole shoes 143 both extend in the circumferential direction of the rotor 50 and away from the first sidewall 141, and the extension ends of the two pole shoes 143 are spaced away from each other, such that an outer profile of cross-sections of the two pole shoes 143 is substantially V-shaped or arc-shaped and hence an outer profile of the cross-section of the stator tooth 14 is substantially Y-shaped.

Further, the extension end of each pole shoe 143 is close to an extension end of the extension 1231 of the auxiliary tooth 1230 adjacent the pole shoe 143. As a result, the pole shoes 143 of the stator teeth 14 and the extensions 1231 of the auxiliary teeth 1230 cooperatively form a receiving space 16 for receiving the rotor 50 therein. At the same time, each pole shoe 143, the extension 1231 adjacent the pole shoe 143 and the stator yoke 12 cooperatively form a receiving slot 15 for receiving the winding 30 therein.

Further, the distal end of each pole shoe 143 and the distal end of the extension 1231 adjacent the pole shoe 143 are spaced by a preset distance to form an opening 18, thereby reducing magnetic leakage. It should be understood that the distal end of the extension 1231 and adjacent pole shoe 143 can also be connected by a magnetic bridge with a large magnetic reluctance.

The rotor 50 is rotatably received in the stator core 10. In the illustrated embodiment, specifically, the rotor 50 includes a rotary shaft 52, a rotor core 54, and permanent magnetic poles 56. The rotor core 54 is disposed around the rotary shaft 52, and the permanent magnetic poles 56 are disposed around the rotor core 54. It should be understood that the permanent magnetic poles 56 can also be directly fixed to the rotary shaft 52.

Referring again to FIG. 3, in this embodiment, the rotary shaft 52 is generally a cylindrical shaft which is rotatably disposed in the box 21. The rotary shaft 52 defines an axis coaxial with an axis of the stator core 10 and extending toward the receiving slot 2131. The rotary shaft 52 is used to connect to the transmission assembly 400 and drive the transmission assembly 400 to move.

The rotor core 54 is fixedly attached around the rotary shaft 52 and is received in the receiving space 16.

Preferably, an outer circumferential surface of each permanent magnetic pole 56 away from the rotor core 54 is located on a same cylindrical surface centered at the center of the rotor 50, such that an outer profile of cross sections of the permanent magnetic poles 56 is generally circular-shaped.

Further, an inner surface of a connection area of the two pole shoes 143 of each stator tooth 141 is formed with a recess 1433, and a connection area of the two extensions 1231 of each auxiliary tooth 1230 is formed with a recess 1233. The inner surfaces of the pole shoes 143 of the stator teeth 14 and the extensions 1231 of the auxiliary teeth 1230 of the stator core 10 are located on a same cylindrical surface centered at the center of the rotor 50, except for the parts of the recesses 1233, 1433. As such, the stator and the rotor form therebetween a substantially even air gap. That is, the air gap is even, except for the portions corresponding to the recesses 1233, 1433, the openings 18 and opening slots between adjacent permanent magnetic poles 56.

In this embodiment, the provision of the recesses 1433, 1233 makes a pole axis L2 of the rotor (a center line of the permanent magnetic pole) able to be offset from a pole axis L1 of the stator (a center line of the stator tooth) by a certain angle. An included angle Q between the rotor pole axis and the stator pole axis is referred as a startup angle. Preferably, the recesses 1433, 1233 are aligned with centers of the stator teeth 14 and the auxiliary teeth 1230, respectively, such that the startup angle Q is equal to or close to a 90-degree electric angle, which makes the rotor 50 easily achieve bidirectional startup. By altering the direction of the electric current in the winding 30, the startup direction of the rotor 50 can be changed.

It should be understood that the positions of the recesses 1433, 1233 can be changed depending upon design requirements. For example, the recesses 1433, 1233 are all offset from the centers of the stator teeth 14 and auxiliary teeth 1230 along a clockwise direction or a counter-clockwise direction, such that the rotor 50 starts easier in one direction than in the other direction.

In this embodiment, there are four permanent magnet members. The four permanent magnet members are fixedly disposed on an outer circumferential surface of the rotor core 54 and are spaced along the circumferential direction of the rotor core 54. Each permanent magnet member forms one of the permanent magnetic pole 56, and two adjacent permanent magnetic poles 56 have opposite polarities. The winding 30 includes two coils respectively wound around the two stator teeth 14. Each coil is wound around the winding portion 141 of one corresponding stator tooth 14 after passing through the corresponding receiving slot 15. When an electric current flows through the winding 30, the energized winding 30 produces an induction magnetic field. Magnetic fluxes produced by each energized coil enter the rotor 50 through the pole shoes 143 of the corresponding stator tooth 14, enter the rotor 50 through an air gap between the pole shoes 143 and the rotor 50, and go back to the stator tooth 14 through the extensions 1231 of the two auxiliary teeth 1230 adjacent the pole shoes 143 and the stator yoke 12 to thereby form magnetic flux loops. That is, the magnetic fluxes produced by each energized coil go sequentially through the winding portion 141, the two corresponding pole shoes 143, the air gap between the pole shoes 143 and the rotor 50, the rotor 50, the air gap between two of the extensions 1231 adjacent to the two pole shoes 143 and the rotor 50, the two corresponding extensions 1231, and the stator yoke 12 to form two closed magnetic flux loops. Therefore, in this embodiment, upon being energized, the two coils can form four magnetic flux loops, i.e. forming a four-pole motor. In comparison with the traditional two-pole motor (no auxiliary poles are formed on the stator), the present invention reduces the magnetic path and magnetic reluctance, thereby increasing the output power of the driving assembly 100.

It should be understood that the outer surfaces of the four permanent magnetic poles 56 shall not be limited to the concentric circular arc surfaces as described above. For example, the outer surfaces of the four permanent magnetic poles 56 may be eccentric circular arc surfaces. For example, the outer surface of each permanent magnetic pole 56 is spaced from the center of the rotor by a distance that progressively decreases in a circumferential direction of the rotor from a middle to two ends of the outer surface and is symmetrical with respect to a center line of the outer surface, such that the outer surface of each permanent magnetic pole and the stator form therebetween an uneven air gap that is substantially symmetrical with respect to the center line of the outer surface.

Preferably, the motor winding is single-phase connected in this embodiment, i.e. the driving assembly 100 is a single phase permanent magnet brushless motor. Therefore, the above driving assembly 100 is a four-pole single phase permanent magnet brushless motor. Because the single phase permanent magnet brushless motor includes only two opposingly disposed stator teeth 14, and the two coils are respectively disposed on the two stator teeth 14, when the distance between the two first sidewalls 121 of the stator yoke 12 is fixed, the distance between the two second sidewalls 123 may be set to be relatively smaller. Therefore, with the overall size of the single phase permanent magnet brushless motor being reduced, the overall weight of the driving mechanism 1 is also reduced, and the output power of the single phase brushless motor is relatively greater. In addition, when the single phase brushless motor is disposed in the box 21, an outer iron housing of the traditional motor is omitted, which further reduces the space occupied by the motor, such that the overall size of the driving mechanism 1 is relatively smaller. Furthermore, the outer shape of the motor of the embodiment of the present invention is generally rectangular/obround, with its width (i.e. the size of one pair of opposite sides) being less than its length (i.e. the size of the other pair of opposite sides). The outer shape of the motor matches with the shape of the receiving chamber 2111 of the box 21. In the driving mechanism as configured above, the box 21 has a low profile structure (a size in a direction perpendicular to the second sidewall 123 of the motor is obviously less than a size in a direction parallel to the second sidewall 123), which is particularly suitable for use in applications with low profile space such as vehicle window lifting. In the motor of the embodiment of the present invention, a ratio of a maximal outer diameter of the rotor (i.e. a maximal outer diameter of the rotor corresponding to the permanent magnet members) to a width of the stator core (the distance between the outer surfaces of the two second sidewalls 123) can be greater than 0.6. That is, the rotor can be made as large as possible, thus increasing the output power of the motor.

It should be understood that the number of the permanent magnetic poles 56 shall not be limited to four, which can be six, eight, ten, or even more. Likewise, the number of the stator teeth 14 shall not be limited to two, which can be four, six, eight, ten, or even more, as long as the number of the permanent magnetic poles 56 is two times of the number of the stator teeth 14. Correspondingly, the number of the auxiliary teeth 1230 shall not be limited to two as described above, which can be four, six, eight, ten, or even more, as long as the number of the auxiliary teeth 1230 is equal to the number of the stator teeth 14, and the number of the coils is equal to the number of the stator teeth 14.

In short, the number relationship between the stator teeth, auxiliary teeth, coils and permanent magnetic poles 56 should satisfy the following conditions: the number of the stator teeth 14, the auxiliary teeth and the coils is n, the n stator teeth 14 and the n auxiliary teeth 1230 are alternatively spaced along the circumferential direction of the stator yoke 12, and each coil is wound around one corresponding stator tooth 14; the number of the permanent magnetic poles 56 is 2n. When the n coils are energized, n main magnetic poles having the same polarity can be produced respectively at the n stator teeth 14, and n auxiliary magnetic poles having a polarity opposite to the polarity of the main magnetic poles can be produced respectively at the n auxiliary teeth 1230. Wherein, n is a positive integer greater than 1. In the above motor, upon the winding 30 being energized, the main magnetic pole and the auxiliary magnetic pole adjacent the main magnetic pole can form the magnetic flux loop therebetween. In comparison with the traditional two-pole motor, the magnetic path is improved. To obtain the same output power, material consumption of the winding and the stator core of the motor can be reduced, which can therefore reduce cost. On the other hand, when the outer diameter of the rotor is fixed, the size of the stator core may be set to be relatively smaller, which reduces the overall size of the motor and hence the overall size of the driving mechanism.

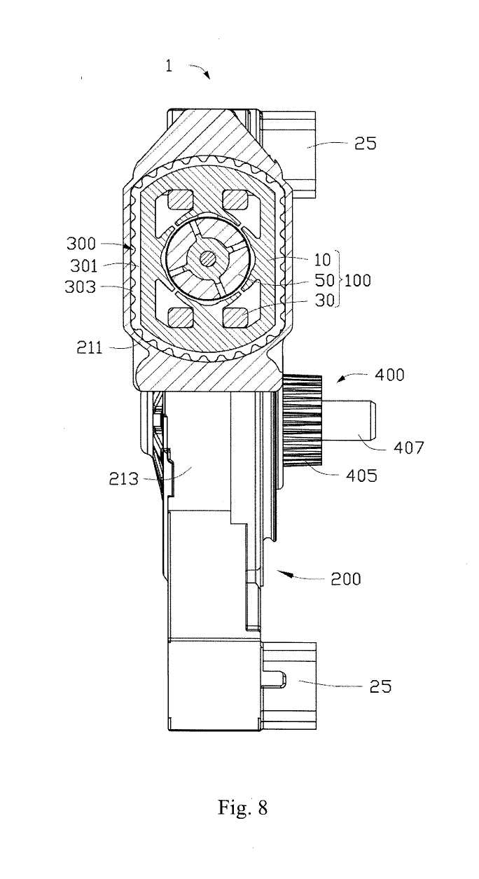

Referring also to FIG. 8, the buffering member 300 is disposed between the stator core 10 and the first receiving portion 211. The buffering member 300 is used to buffer external vibrations applied to the driving assembly 100 and absorb the vibrations caused by the driving assembly 100 during operation, such that the driving mechanism 1 overall has a small amount of vibrations, thus reducing the noises of the driving mechanism 1 during operation.

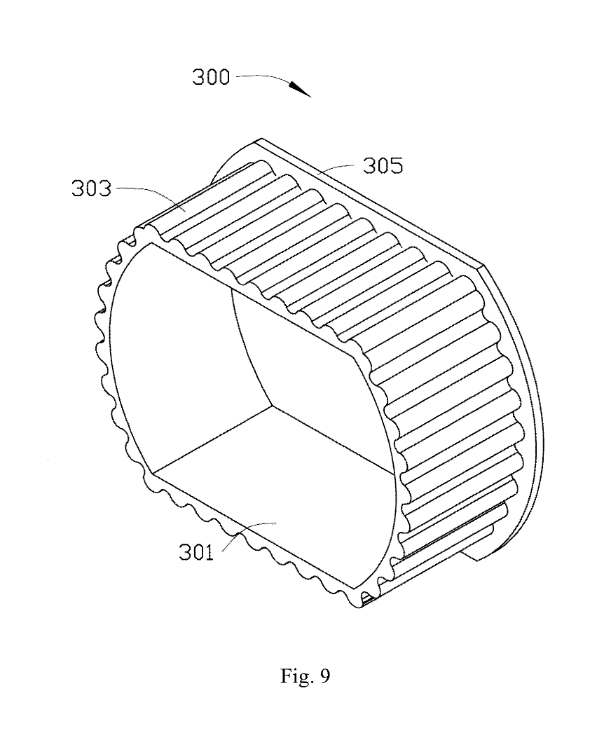

Referring to FIG. 9 and FIG. 3, a profile of the buffering member 300 substantially matches with the outer profile of the stator core 10, and the buffering member 300 is attached around the stator core 10. When the stator core 10 and the buffering member 300 are received in the first receiving portion 211, a sidewall of the receiving chamber 2111 applies a precompression force to the buffering member 300, such that the stator core 10 of the driving assembly 100 can be firmly mounted in the box 21.

The buffering member 300 includes a sleeve portion 301, a buffering portion 303, and a retaining portion 305. In the illustrated specific embodiment, the buffering portion 303 and the retaining portion 305 are both disposed on the sleeve portion 301.

The sleeve portion 301 is of a generally ring-shaped column structure, which sleeves around an outer circumference of the stator core 10.

In this embodiment, the buffering portion 303 includes a buffering protrusion, and there are a plurality of the buffering portions 303. The buffering portions 303 are disposed on an outer circumference of the sleeve portion 301 and spaced along a circumferential direction of the sleeve portion 301. Each buffering portion 303 is a substantially elongated protrusion which protrudes from an outer surface of the sleeve portion 301 and extends along an axial direction of the sleeve portion 301. The buffering portions 303 surround an outer circumferential surface of the sleeve portion 301, which makes an outer profile of a cross-section of the buffering member 300 is substantially wave-shaped, thus providing sufficient space for deformation of the buffering member 300 and hence enhancing the buffering and damping results of the buffering member 300. It should be understood that the extending direction of the buffering portion 303 shall not be limited to the axial direction of the sleeve portion 301 as described above. Rather, the extending direction of the buffering portion 303 may also be at an angle relative to the axis of the sleeve portion 301, or the buffering portion 303 may be curvedly formed on the outer circumferential surface of the sleeve portion 301. It should also be understood that the shape of the buffering portion 303 shall not be limited to the elongated protrusion as described above, which can also be of another structure. For example, the buffering portion 303 may be configured to be a ball-shaped, cubic, or prism-shaped buffering protrusion, as long as the buffering portions 303 are spaced on the outer circumferential surface of the sleeve portion 301 to provide sufficient space for deformation of the buffering member 300. Alternatively, the buffering portions 303 may be configured to have a combination of the above shapes, as long as the buffering portions 303 are spaced on the outer circumferential surface of the sleeve portion 301 to provide sufficient space for deformation of the buffering member 300.

The retaining portion 305 is substantially in the form a flange, which has an outer diameter size greater than an outer diameter size of the sleeve portion 301 and the buffering portion 303. The retaining portion 305 is disposed adjacent one end of the sleeve portion 301 adjacent the cover body 23, and is retained on the first receiving portion 211 of the box 21. When the stator core 10 and the buffering member 300 are received in the first receiving portion 211 and the cover body 23 is fixed to the box 21, the retaining portion 305 is sandwiched between the cover body 23 and the box 21 (FIG. 4) in an axial direction of the motor, to achieve energy absorption and vibration damping between the cover body 23 and the box 21 and, as the same time, achieves dustproof seal function. Preferably, the cover body 23 is connected to the box 21 through a thread connection piece and exerts a precompression force to the retaining portion 305, such that the buffering member 300 and the driving assembly 100 can be firmly mounted to the box 21.

The buffering member 300 is directly disposed between the stator core 10 and the box 21, which can effectively buffer the vibrations produced by the driving assembly 100 during operation and facilitates the overall assembly of the driving mechanism 1.

Referring again to FIG. 2 and FIG. 3, the transmission assembly 400 is disposed in the second receiving portion 213 and connected to the rotary shaft 52. The transmission assembly 400 is used to connect to the external device and drive the external device to move.

The transmission assembly 400 includes a first transmission member 401, a second transmission member 403, and an output member 405. In the illustrated specific embodiment, the first transmission member 401 is disposed on the rotary shaft 52, the second transmission member 403 is disposed within the second receiving portion 213 and connected to the first transmission member 401, and the output member 405 is driven by the second transmission member 403.

In this embodiment, the transmission assembly 400 is a worm/worm gear mechanism. The first transmission member 401 is a worm, the second transmission mechanism 403 is a worm gear, and the output member 405 is an output gear. Specifically, the first transmission member 401 is fixedly disposed on the rotary shaft 52 and can rotate relative to the mounting assembly 200 along with the rotary shaft 52. The second transmission assembly 403 is rotatably disposed in the second receiving portion 213 and engaged with the first transmission member 401. A double gear forms the worm gear 403 and the output member 405. The double gear is capable of rotation about a support shaft 407. The support shaft 407 can be fixed to the box 21, and the output member 405 passes through the box 21 and protrudes to the outside environment. The output member 405 is used to connect to the external device. When the rotary shaft 52 of the driving assembly 100 rotates, the rotary shaft 52 drives the second transmission member 403 to rotate through the first transmission member 401, such that the output member 405 drives the external device to move. The output member 405 can be engaged with a part (such as a gear or rack) of the external device, for allowing the driving assembly 100 to drive the external device to move through the transmission assembly 400.

It should be understood that the transmission assembly 400 shall not be limited to the worm/wog n gear structure as described above, which can also be of another transmission structure. For example, the transmission assembly 400 may be a gear train transmission mechanism. The gear train is disposed in the box 21 and connected to the rotary shaft 52 to transmit the movement of the driving assembly 100 to the external device. Alternatively, the transmission assembly 400 may be a gear and rack transmission mechanism, a belt and gear transmission mechanism or another type of transmission mechanism, as long as the driving assembly 100 can drive the external device to move through the transmission mechanism.

Referring to FIG. 10, the driving mechanism 1 provided by the embodiment of the present invention can be utilized in a vehicle 3 to drive a part of the vehicle 3 to move. In particular, the driving mechanism 1 can be used as a vehicle window driving mechanism. The vehicle 3 may include a vehicle body, a door disposed on the vehicle body, and a vehicle window 2 disposed on the door. The driving mechanism 1 is disposed within the vehicle door and connected with the vehicle window 2 through the transmission assembly 400. Preferably, the output member 405 of the transmission assembly 400 is connected to the vehicle window 2 through another transmission part (such as a gear rack), so as to convert the rotation of the driving assembly 100 into translation of the vehicle window 2. Controlling the rotation of the driving assembly 100 can control upward or downward movement of the vehicle window 2 relative to the vehicle door, thus opening or closing the vehicle window 2. Because the driving mechanism 1 of the present invention has the advantages of small size and lightweight, it occupies a smaller mounting space within the vehicle door and can be firmly mounted. In this embodiment, other structures of the vehicle are known structures, which are not described herein in detail.

The driving mechanism 1 provided by the embodiment of the present invention can also be utilized in another type of movable device to drive the movable device itself or/and drive a part of the movable device to move.

For example, the driving mechanism 1 may be utilized in a remote-controlled vehicle. The driving mechanism 1 is connected to a wheel of the remote-controlled vehicle to drive the wheel to rotate, thus driving the remote-controlled vehicle to move. Because the driving mechanism 1 of the present invention has the advantages of small size and lightweight, it occupies a small mounting space within the remote-controlled vehicle and can be firmly mounted. In this embodiment, other structures of the remote-controlled vehicle are known structures, which therefore are not described herein in detail. Alternatively, the driving mechanism 1 may be also utilized in a fan blade driving system of a device such as a fan or heat sink, which are not described herein one by one.

Although the invention is described with reference to one or more embodiments, the above description of the embodiments is used only to enable people skilled in the art to practice or use the invention. It should be appreciated by those skilled in the art that various modifications are possible without departing from the spirit or scope of the present invention. The embodiments illustrated herein should not be interpreted as limits to the present invention, and the scope of the invention is to be determined by reference to the claims that follow.

1. A driving mechanism comprising:
a box;
a motor being at least partially received in the box; and
a buffering member attached to an outer circumference of the motor and disposed between the motor and the box.

2. The driving mechanism of claim 1, further comprising a cover body, wherein the box comprises a first receiving portion, the motor is disposed in the first receiving portion, and the cover body covers a portion of the motor that is exposed out of the first receiving portion.

3. The driving mechanism of claim 2, wherein the buffering member comprises a sleeve portion attached around the outer circumference of the motor and a buffering portion disposed on the sleeve portion, and the buffering portion is disposed between the sleeve portion and the first receiving portion.

4. The driving mechanism of claim 3, wherein a structure of the buffering portion comprises at least one type of an elongated buffering protrusion, a ball-shaped buffering protrusion and a prism-shaped buffering protrusion.

5. The driving mechanism of claim 3, wherein the buffering member further comprises a retaining portion, the retaining portion is a flange disposed at one end of the sleeve portion, and the retaining portion is sandwiched between the cover body and the first receiving portion of the box.

6. The driving mechanism of claim 2, wherein the first receiving portion defines a receiving chamber, the motor is at least partially received in the receiving chamber, the driving mechanism further comprises a transmission assembly, the box further comprises a second receiving portion defining a receiving slot, the receiving slot is in communication with the receiving chamber, and the transmission assembly is disposed in the receiving slot and connected to the motor.

7. The driving mechanism of claim 1, wherein the motor is a permanent magnet brushless motor.

8. The driving mechanism of claim 1, wherein the motor is a single phase permanent magnet brushless motor.

9. The driving mechanism of claim 1, wherein the motor comprises a stator and a rotor, the stator comprises a stator core and a winding, the stator core comprises a stator yoke and stator teeth coupled to the stator yoke, the winding is wound around the stator teeth, the buffering member is disposed at an outer circumference of the stator core, and the rotor is received in the stator core.

10. The driving mechanism of claim 9, wherein the stator yoke comprises two opposite first sidewalls and two opposite second sidewalls, the first sidewalls and the second sidewalls are connected such that the stator yoke is substantially rectangle shaped, the stator teeth are coupled to the first sidewalls.

11. The driving mechanism of claim 10, wherein a maximal distance between outer surfaces of the two first sidewalls is greater than a maximal distance between outer surfaces of the two second sidewalls.

12. The driving mechanism of claim 10, wherein the number of the stator teeth is two, each stator tooth comprises a winding portion and pole shoes coupled to the winding portion, the winding portion is connected to one corresponding first sidewall, the pole shoes are disposed at one end of the winding portion away from the first sidewall and faces toward the rotor, and the winding comprises two coils each wound around the winding portion of one corresponding stator tooth.

13. The driving mechanism of claim 12, wherein one side of each second sidewall facing toward the rotor forms two extensions, one end of each extension away from the second sidewall extends in a direction away from the second sidewall and away from the other extension, all the pole shoes and all the extensions cooperatively define a receiving space in which the rotor is received.

14. The driving mechanism of claim 13, wherein each pole shoe and the adjacent extension are connected by a magnetic bridge or interrupted by an opening.

15. The driving mechanism of claim 14, wherein one side of the pole shoe facing toward the rotor defines a recess, and one side of the extension facing toward the rotor defines a recess.

16. The driving mechanism of claim 9, wherein the rotor comprises a rotary shaft ratatably disposed in the box, a rotor core disposed around the rotary shaft, and a plurality of permanent magnetic poles disposed around the rotor core.

17. The driving mechanism of claim 16, wherein the number of the permanent magnetic poles is four, and the four permanent magnetic poles are spaced along a circumferential direction of the rotor core.

18. The single phase permanent magnet motor of claim 17, wherein outer surfaces of the permanent magnetic poles are located on a same cylindrical surface.

19. The single phase permanent magnet motor of claim 17, wherein an outer surface of each permanent magnetic pole is spaced from a center of the rotor by a distance that progressively decreases in a circumferential direction of the rotor from a middle to two ends of the outer surface and is symmetrical with respect to a center line of the outer surface.

20. A vehicle comprising:
a vehicle window; and
a driving mechanism, comprising:
a box;
a motor being at least partially received in the box;
a buffering member attached to an outer circumference of the motor and disposed between the motor and the box; and
a transmission assembly coupled to the motor and the vehicle window;
wherein the motor moves the vehicle window through the transmission assembly.
